(19) United States
(12) Patent Application Publication
(10) Pub. No.: US 2025/0139299 A1
(43) Pub. Date: May 1, 2025

(54) Method to Identify Consumer Electronics Products

(71) Applicant: DIVX, LLC, San Diego, CA (US)

(72) Inventors: Eric William Grab, San Diego, CA (US); Kourosh Soroushian, San Diego, CA (US); Tung Lin, San Diego, CA (US); Francis Yee-Dug Chan, San Diego, CA (US); Evan Wallin, San Diego, CA (US)

(73) Assignee: DIVX, LLC, San Diego, CA (US)

(21) Appl. No.: 19/004,089

(22) Filed: Dec. 27, 2024

Related U.S. Application Data
(63) Continuation of application No. 16/844,631, filed on Apr. 9, 2020, now abandoned.
Application No. 16/844,631 is a continuation of application No. 13/436,888, filed on Mar. 31, 2012, now abandoned.
(60) Provisional application No. 61/581,598, filed on Dec. 29, 2011.
(60) Provisional application No. 61/503,581, filed on Jun. 30, 2011.

(51) Int. Cl. G06F 21/73; G06F 21/10; G06F 21/33; G06F 21/60

(52) U.S. Cl. CPC G06F 21/73; G06F 21/10; G06F 21/33; G06F 21/604

(57) ABSTRACT

Systems and methods for identifying consumer electronic products using a playback device with a product identifier in accordance with embodiments of the invention are disclosed. In one embodiment, a playback device includes a processor and memory configured to store a product identifier, where the product identifier is associated with a specific product and is associated with cryptographic information, wherein the processor is configured by a client application to request content from a server, communicate the product identifier to a server, and receive encrypted content accessible using cryptographic information including the cryptographic information associated with the product identifier.

### CROSS-REFERENCE TO RELATED APPLICATIONS

The current application is a continuation of U.S. patent application Ser. No. 16/844,631, filed Apr. 9, 2020, which is a continuation of U.S. patent application Ser. No. 13/436,888, filed Mar. 31, 2012, which claims priority to U.S. Provisional Application No. 61/581,598, filed Dec. 29, 2011 and U.S. Provisional Application No. 61/503,581, filed Jun. 30, 2011, the disclosures of which are incorporated herein by reference in their entireties.

### FIELD OF THE INVENTION

The present invention relates generally to managing consumer electronics products operating on a digital rights management (DRM) system, and more specifically to systems and methods for reliably identifying a class of device by product line using an identifier.

### BACKGROUND OF THE INVENTION

A consumer electronic or CE device is typically built using a specific chipset designed for a specific class of consumer electronics device (e.g. high definition televisions). Many original equipment manufacturers (OEMs) can utilize the same chipset to produce a similar product. The OEMs differentiate the products using different firmware to modify the user interface and the capabilities of the device. In many instances, products manufactured by an OEM that share a common chipset and firmware are referred to as a product line.

A common capability of CE devices is the playback of multimedia content. A variety of digital rights management (DRM) systems exist to prevent unauthorized playback of protected content. DRM systems typically encrypt content so that a specific cryptographic key or combination of cryptographic keys is required to play back the content. Playback devices typically register with the DRM system to obtain the keys that are necessary to play back protected content.

A DRM system owner/operator may implement a certification system, through which it “approves” a device model or product line to operate on its DRM system. Certification typically involves the DRM system operator testing that the device and/or chipset and firmware combination that defines a product line operates in the manner required for operation within the DRM system. Once a device model or product line is approved to operate within a DRM system, purchasers of approved devices can register the devices with the DRM system and play protected content authorized for playback on the registered device.

### SUMMARY OF THE INVENTION

Systems and methods for identifying consumer electronic products using a playback device with a product identifier in accordance with embodiments of the invention are disclosed. In one embodiment, a playback device includes a processor and memory configured to store a product identifier, where the product identifier is associated with a specific product and is associated with cryptographic information, wherein the processor is configured by a client application to request content from a server, communicate the product identifier to a server, and receive encrypted content accessible using cryptographic information including the cryptographic information associated with the product identifier.

In a further embodiment, the processor is further configured by a client application to communicate a product identifier version to the server.

In another embodiment, the memory is further configured to store product tag data associated with the product identifier, and the product tag data includes at least one product tag that describes a characteristic of the product.

In a still further embodiment, the processor is further configured by a client application to transmit product tag data to a server and receive confirmation from the server whether a first product credential reference identifier that is generated from the transmitted product tag data matches a second product credential reference identifier stored on the server.

In still another embodiment, product tag data includes at least one tag selected from the group consisting of: product ID version, brand, ODM/manufacturer, device type, model number, base model number, silicon platform ID, certified playback profile, country, and digital secure adaptive streaming software version.

In a yet further embodiment, the memory is further configured to store a product credential reference identifier that is associated with the product identifier and is generated using at least the product identifier and at least a portion of the product tag data.

In yet another embodiment, the method used to generate the product credential reference identifier is determined based upon a product identifier version.

In a further embodiment again, the cryptographic information associated with the product identifier includes a product key.

In another embodiment again, the memory is further configured to store user account data.

In a further additional embodiment, the user account data includes a user identifier and cryptographic information associated with the user identifier.

In another additional embodiment, the cryptographic information associated with the user identifier includes a user key and product SSL certificate.

In a still yet further embodiment, the processor is further configured by a client application to receive cryptographic information associated with a user identifier and store the cryptographic information in memory.

In still yet another embodiment, the content encrypted using the cryptographic information associated with the product identifier includes the cryptographic information associated with the user identifier.

In a still further embodiment again, the cryptographic information associated with the product identifier includes a product key and the processor is further configured by a client application to access the cryptographic information associated with a user identifier using the product key.

In still another embodiment again, the cryptographic information associated with the product identifier includes a product key and the processor is further configured by a client application to access the cryptographic information associated with a user identifier using the product key and a device key.

In a still further additional embodiment, the second product credential reference identifier is stored on the server and associated with product tag data stored on the server.

In still another additional embodiment, the second product credential identifier is stored in the memory and associated with the product tag data stored in the memory and the processor is further configured by a client application to transmit the second product credential identifier to the server.

In a yet further embodiment again, a method of identifying a playback device including a product identifier includes communicating a product identifier to a server, where the product identifier is associated with a specific product and is associated with cryptographic information, requesting content from the server, and receiving encrypted content accessible using cryptographic information including the cryptographic information associated with the product identifier.

In yet another embodiment again, the method includes communicating a product identifier version to the server.

In a yet further additional embodiment, the method includes associating product tag data with the product identifier, where the product tag data includes at least one product tag that describes a characteristic of the product, and storing the product tag data in memory.

In yet another additional embodiment, the product tag data includes at least one tag selected from the group consisting of: product ID version, brand, ODM/manufacturer, device type, model number, base model number, silicon platform ID, certified playback profile, country, and digital secure adaptive streaming software version.

In a further additional embodiment again, the method includes associating a product credential identifier with the product identifier, where the product credential reference identifier is uniquely generated using at least the product identifier and at least a portion of the product tag data, and storing the product credential identifier in memory.

In another additional embodiment again, the method used to generate the product credential reference identifier is based upon a product identifier version.

In a still yet further embodiment again, the cryptographic information includes a product key.

In still yet another embodiment again, the method includes receiving and storing user account data.

In a still yet further additional embodiment, the user account data includes a user identifier and cryptographic information associated with the user identifier.

In still yet another additional embodiment, the cryptographic information associated with the user identifier includes a user key and product SSL certificate.

In a yet further additional embodiment again, the method includes accessing the cryptographic information associated with a user identifier using a product key and a device key.

In yet another additional embodiment again, the content encrypted using the cryptographic information associated with the product identifier includes the cryptographic information associated with the user identifier.

In a still yet further additional embodiment again, the method includes receiving a request for product tag data from a server, transmitting product tag data to the server, and receiving confirmation from the server whether a first product credential reference identifier that is generated from the transmitted product tag data matches a second product credential reference identifier.

In still yet another additional embodiment again, the method includes retrieving a second product credential reference identifier from memory and transmitting the second product credential reference identifier to the server.

In another further embodiment, a machine readable medium contains processor instructions, where execution of the instructions by a processor causes the process to perform a process including communicating a product identifier to a server, where the product identifier is associated with a specific product and is associated with cryptographic information, requesting content from the server, and receiving content encrypted using cryptographic information including the cryptographic information associated with the product identifier.

In still another further embodiment, a method for certifying a consumer electronics product includes receiving product tag data, storing a product identifier, a product credential reference identifier, and at least one product tag from the received product tag data on a registration server so that the product credential reference identifier and the at least one product tag are associated with the product identifier, storing the product identifier, the product credential reference identifier, and at least one product tag from the received product tag data on a device, and retrieving the product credential reference identifier and at least one product tag stored on the device to display in human-readable format.

In yet another further embodiment, the method includes receiving input of the product credential reference identifier and the at least one product tag stored on the device into a certification terminal and transmitting the product credential reference identifier and the at least one product tag to the registration server.

In another further embodiment again, the product tag data includes at least one tag selected from the group consisting of: product ID version, brand, ODM/manufacturer, device type, model number, base model number, silicon platform ID, certified playback profile, country, and digital secure adaptive streaming software version.

In another further additional embodiment, the product credential reference identifier is generated using at least the product identifier and one product tag.

In a further embodiment, the product credential reference identifier is generated using a cryptographic hash function.

In another embodiment, receiving product tag data includes receiving an electronic transmission that includes the product tag data over a network.

### BRIEF DESCRIPTION OF THE DRAWINGS

FIG. 1 is a system-level overview illustrating a DRM and content distribution system in accordance with an embodiment of the invention.

FIG. 2A is a chart listing product tags in accordance with an embodiment of the invention.

FIG. 2B conceptually illustrates product tags forming a set of product tag data.

FIG. 2C conceptually illustrates the relationship between a product descriptor, a product ID, product tags (both constant and variable), and a credential reference identifier in accordance with an embodiment of the invention.

FIG. 3 conceptually illustrates a playback device, which stores information related to a user account and a product identifier and cryptographic data used to decode content in accordance with an embodiment of the invention.

FIG. 4 conceptually illustrates a registration server, which stores information related to user accounts including (but not limited to) cryptographic data, in accordance with an embodiment of the invention.

FIG. 5 is a flow chart illustrating a process that can be used to generate a product identifier and associate the product identifier with product tag data in accordance with an embodiment of the invention.

FIG. 6 is a flow chart illustrating a process for verifying the correct storage of a product identifier and associated information on a playback device.

FIG. 7 is a flow chart illustrating a process for checking revocation status of a product identifier and communicating secure data from a server to a device based upon the product identifier.

### DETAILED DESCRIPTION

Turning now to the drawings, systems and methods for identifying consumer electronic products using a playback device with a product descriptor are illustrated. In many embodiments of the invention, playback devices operate within a digital rights management (DRM) system in which they communicate with different types of servers over a network. In many embodiments, the playback devices are certified for use in the DRM system. Certification is an endorsement by a DRM system operator that devices in a particular product line have been tested to be compatible with the DRM system. It may be tempting for a device manufacturer to resort to a form of counterfeiting, by taking firmware that was written for the chipset of one model of device and placing it on another model of device that uses the same chipset. This improper use of the issued device certification can present technical difficulties in interoperability with the DRM system and is typically motivated by a desire to avoid paying royalties and/or other contractual obligations related to the use of the DRM system with respect to the devices in question.

DRM systems in accordance with many embodiments of the invention utilize a mechanism to identify products by manufacturer and product line in order to enforce certification policies, facilitate confinement of security breaches, and assist with the tracking of revenues. In a number of embodiments, a process for certifying a product and/or product line within a DRM system can include assigning a product descriptor to each product or product line. The term product can be used to refer to both individual products and product lines and is used to refer to both products and product lines throughout the discussion that follows.

In order to facilitate reviewing whether the product ID installed on a specific device is appropriate to the device (i.e. whether the device is the product indicated by the product ID), DRM systems in accordance with a number of embodiments of the invention also store product tag data describing the product on the device and a product credential reference identifier (credential reference ID) generated using some or all of the product tag data. Displaying the product tag data enables a quick visual inspection of whether the characteristics of the device correspond to the product characteristics indicated by the product tags. The product credential reference ID is generated using a subset of the product tags that remain constant through the useful life of the product (constant tags) and can be utilized to verify that the product tag data corresponds to the characteristics of the device. If the product credential reference ID generated using some or all of the product tags does not match the stored product credential reference ID associated with a specific product ID, then tampering is likely present.

In many embodiments, a product ID together with constant product tags and a subset of the product tags that may change over the life of the product (variable product tags) form a product descriptor. Variable product tags can be used to indicate software versions or provide tracking capabilities. The product descriptor can serve to differentiate devices within a product line (i.e., having the same product ID) by their installed software version and/or updates the device has received.

In several embodiments, one or more pieces of cryptographic data (product keys) can also be issued with respect to each product ID and/or product descriptor. The product key(s) can be utilized to issue technically protected content to the device. In the event of a security breach with respect to a specific product, the product key(s) can be revoked to limit the scope of the security breach. DRM systems and methods for identifying different products within a DRM system in accordance with embodiments of the invention are discussed further below.

### System Architecture

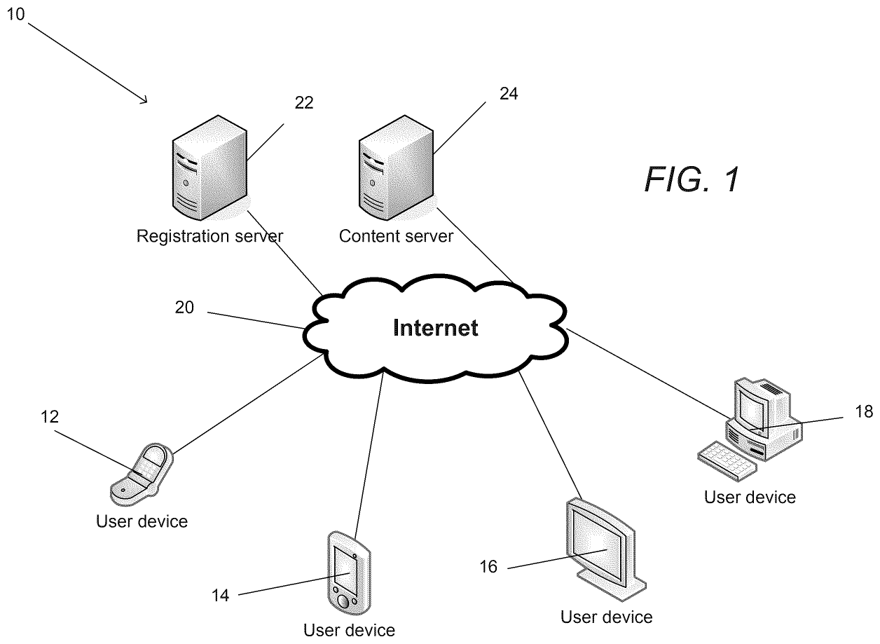

A DRM system in accordance with an embodiment of the invention is illustrated in FIG. 1. The DRM system 10 includes a plurality of consumer electronics devices that include information identifying a specific product or product line to which the device belongs. In the illustrated embodiment, the consumer electronics devices include devices with content playback capabilities such as (but not limited to) a cellular phone 12, smart phone 14, television 16, personal computer 18, DVD player, or digital media player. The consumer electronics devices are configured to communicate with remote servers via a network 20 such as the Internet. In the illustrated embodiment, the DRM system includes a registration server 22 and content server 24. Devices typically first connect to a registration server to be associated with a user account and acquire credentials/cryptographic data (e.g., SSL certificate, encryption keys) used to access content. Devices may then connect to a content server and request content with the credentials. The content server can issue the requested content in such a way that the credentials/cryptographic data (e.g., SSL certificate, encryption keys) of the device are required to access the content.

A variety of techniques can be utilized to identify a specific product. In a number of embodiments, a product descriptor that includes a product ID is assigned to each product. The product ID can be generated based upon the characteristics of the product and/or arbitrarily assigned. Variations within a product can be identified by a product descriptor that includes a product ID, variable product tags, and constant product tags. One or more variable product tags can be used to indicate a variation such as different software versions and updates. The product descriptor and/or product ID can be utilized in a variety of processes including (but not limited to) the certification and registration of the device. In several embodiments, the use of the product ID during certification is enhanced by also associating product tag data with the product ID to form a product descriptor. The product tag data describes the product and, when displayed, can be utilized to readily verify whether the characteristics of the device correspond to the characteristics of the product associated with the product ID. In many embodiments, attempts to detect tampering with the product tags can be identified by generating a product credential reference ID using some or all of the product tags. The product credential reference ID can be stored with respect to the product tags originally associated with a product ID. When a product credential reference ID generated using the product tags present on a device do not match with the stored product credential reference ID associated with the product ID, tampering is present. In several embodiments, cryptographic data is also associated with the product ID to enable the quarantining of security breaches with respect to a specific product.

In many embodiments, the product ID, product credential reference ID, product key, and product tag data are stored in non-volatile memory on a playback device. Often, when a playback device is designed and manufactured to be used in a DRM system, the DRM system operator will package into a dataload the encryption keys, algorithms, and/or other information and software instructions necessary for the device to communicate with DRM servers and receive content. In several embodiments of the invention, the product ID and other data is included in the dataload given to a manufacturer for storage on each device.

Although a specific architecture is shown in FIG. 1 any of a variety of architectures can be utilized that enable playback devices to communicate with servers over a network in accordance with embodiments of the invention. Furthermore, much of the discussion that follows relates to the use of the product descriptor, product ID, product credential reference ID, product key(s) and product tag data in the certification of products and authentication of devices. As can readily be appreciated not all of the product credential reference ID, product key(s) and product tag data need be associated with a product ID. Indeed, additional data associated with a product ID can vary depending upon the requirements of a specific application in accordance with embodiments of the invention. Product descriptors, Product IDs, additional data that can be associated with product IDs, and systems and methods for using product IDs and associated data in accordance with embodiments of the invention are discussed further below.

### Product Identifier

In many embodiments of the invention, a product identifier (ID) is a character string that is associated with one or more sets of product tag data, where a set of product tag data is descriptive of a product. Any of a number of methods can be used to generate a product ID, including a random number generator, manual numbering or determination by a person, or systematic methods such as using sequential numbers or globally unique identifiers.

### Product Tag Data

In several embodiments of the invention, a set of product tag data is associated with a product ID. The individual tags represent information about some aspect of a product. In several embodiments of the invention, an original equipment manufacturer (OEM) requests that a product be certified (i.e. issued a product ID) and provides information for the product tags. The DRM system operator certifies the product by verifying that a device that is exemplary of the product passes certain tests. Assuming the product tags accurately describe the device, the DRM system operator can issue a product ID for the product and can associate the product tags with the product ID. Generally, a change in the value of some of the product tags may necessitate a different product ID.

In many embodiments of the invention, some product tags may be constant product tags while other tags are variable product tags. Constant product tags are expected to remain constant and not to change through the life of a product. A product credential reference ID can be generated using some or all of the constant product tags associated with a product, as will be described further below.

Variable product tags may change over the life of the product. Variable tags can be used to track characteristics that may change such as software versions. A product descriptor may be formed using a product ID, variable product tags, and constant product tags, as will be described further below.

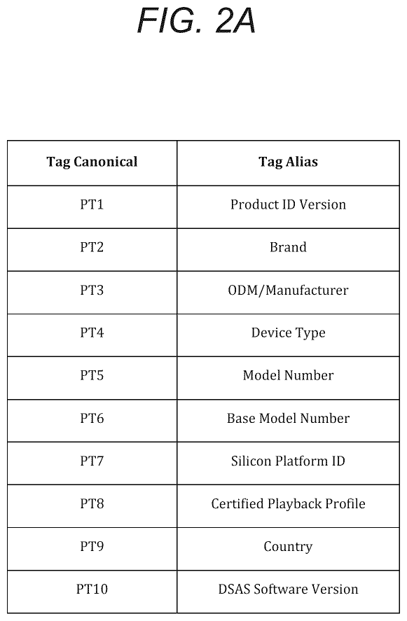

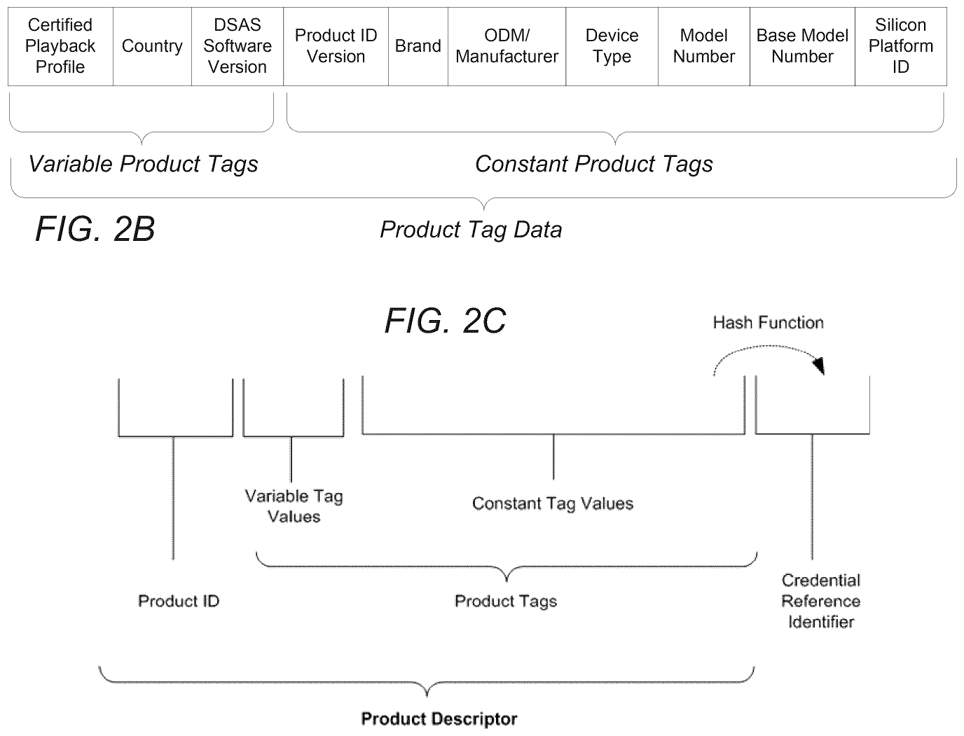

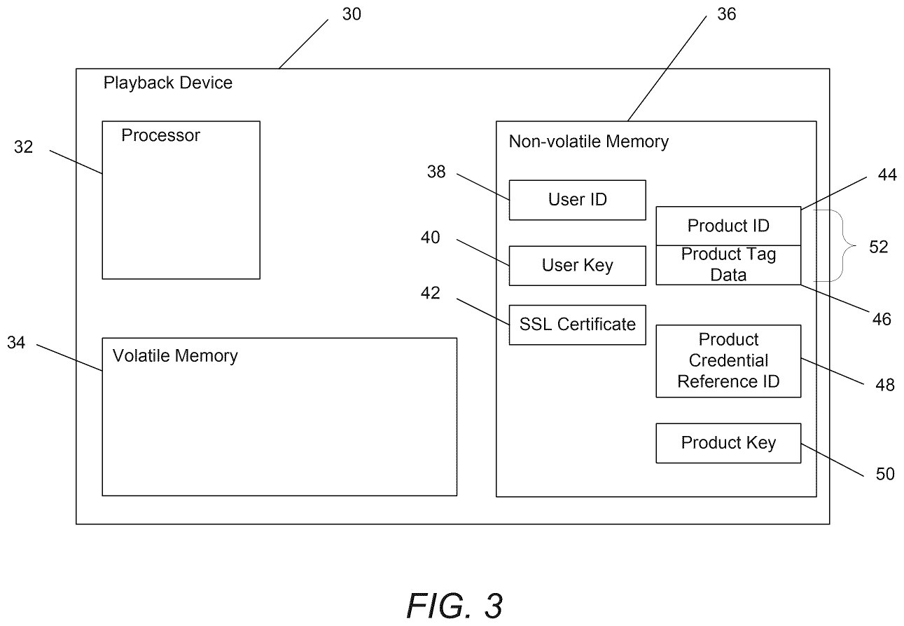

A list of product tags, in accordance with an embodiment of the invention is shown in FIG. 2A. A set of product tag data, including three variable product tags and seven constant product tags, is illustrated in FIG. 2B. There can be other values of product tags that represent the characteristics of the class of device.

Product ID Version (PT1) indicates the version of the product ID creation algorithm used to generate the product ID and product credential reference ID from the product tags. Each version can also specify lengths and format of tag data, as well as the number of tags and the meaning of each tag. In essence, PT1 allows for the product descriptor to be extensible through the definition of new tag names and versions.

The Brand tag (PT2) is the brand that the device is sold under—the name marked on the product and product packaging.

The ODM/Manufacturer tag (PT3) is the company name of the manufacturer of the product. The company may or may not be the same as the Brand. For instance, a product may be designed and manufactured by an original design manufacturer (ODM) and eventually branded by another firm for sale. Or, a company may design and manufacture its own product, in which case the Brand may be the same as the ODM/Manufacturer.

The Device Type tag (PT4) represents the type of product (e.g., DVD player, television). In many embodiments of the invention, the product type is indicated in a license agreement between the company seeking certification and the certifying DRM system owner.

The Model Number tag (PT5) is the model number of the product indicated on the product and product packaging. In some embodiments of the invention, products with different model numbers may have the same product ID so long as they share the same base model number. These may be thought of as related products which often share the same chipset and/or other major components and differ only by some playback features or capabilities. In other embodiments, each product with a distinct model number has a distinct product ID.

The Base Model Number tag (PT6) is the model number of a product's base model. For a base model itself, the value is the same as the Model Number. In many embodiments of the invention, a base model specifies devices using the same chipset and firmware.

The Silicon Platform ID tag (PT7) is the model number of the chipset or processor architecture used in the device.

The Certified Playback Profile tag (PT8) denotes the playback profile or profiles for which the device is certified. A playback profile is defined by a DRM system owner as a set of supported or compatible file types, container formats, playback codecs, resolutions, and/or other features of digital media content.

The Country tag (PT9) is the country name where the product will be shipped and sold.

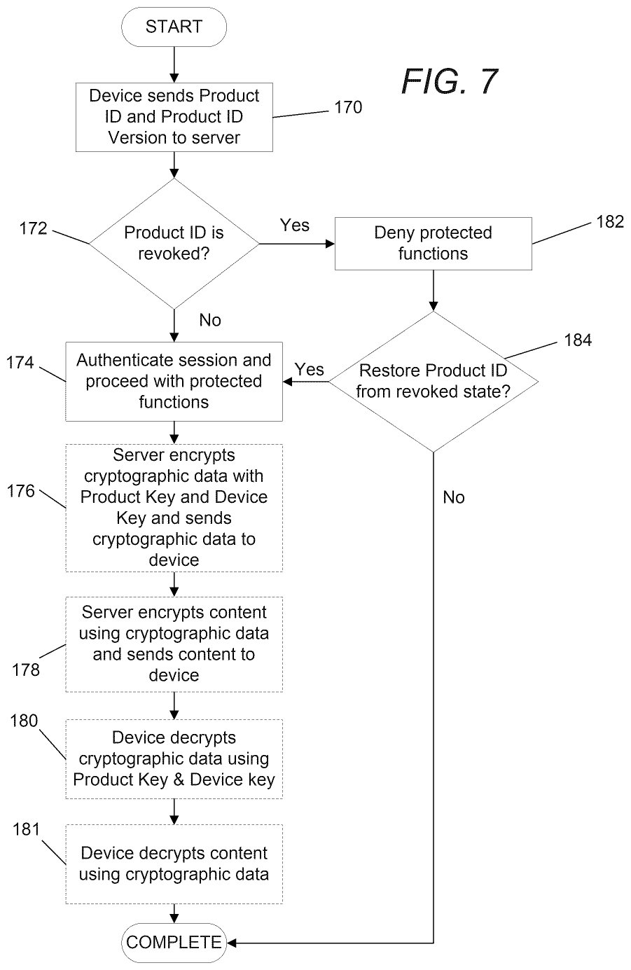

The Digital Secure Adaptive Streaming (DSAS) Software Version tag (PT10) can be used to indicate the version numbers for secure adaptive streaming software components implemented on the device. These may include platform components such as the playback software, operating system, and firmware. As will be discussed further below, the tag may be used to determine various device capabilities when the device plays back content such as in the process described in the discussion of FIG. 7 below.

Although specific tags and fields have been described above, systems and methods in accordance with embodiments of the invention can utilize any of a variety of types of information in product tags that are associated with a product ID.

In several embodiments of the invention, product tag values can be obtained from a device by running an application on the device that will record the values and communicate the values to a server. In addition, the product tags can vary with different types and classes of product. In many embodiments, the constant tags or a subset of the constant tags for a specific device are utilized as device match data for the purpose of registering the device within a DRM system in the manner outlined in U.S. patent application Ser. No. 13/339,315, to Chan et al. entitled “Binding of Cryptographic Content Using Unique Device Characteristics with Server Heuristics” filed Dec. 28, 2011, the disclosure of which is incorporated by reference herein in its entirety. As can readily be appreciated, the constant tags can vary from product descriptor to product descriptor and so the constant tags that are utilized as device match data can also vary from one product descriptor to the next.

### Product Descriptor

In several embodiments of the invention, a product ID identifies devices of a particular product or product line. In further embodiments, a product descriptor can differentiate devices within a product or product line by feature set or software or firmware versions. A product descriptor includes a product ID and product tag data. In many embodiments, product tag data includes constant product tags and variable product tags. The variable product tags in the product descriptor of one device may have different values from the variable product tags in the product descriptor of another device, while having the same product ID. The actual tags used in the product descriptor can vary between product IDs. The relationship between a product descriptor, product ID, variable product tags, constant product tags, and credential reference identifier (product credential reference ID) in accordance with an embodiment of the invention is conceptually illustrated in FIG. 2C.

### Generating a Product Credential Reference Identifier

In several embodiments of the invention, a product credential reference ID is generated using one or more of the product tags and associated with that set of product tags, a product ID, and/or a product descriptor. The product credential reference ID is a unique string of set length generated from some or all of the product tags. In many embodiments of the invention, the product tags used to generate the product credential reference ID are constant product tags. The product credential reference ID is an efficient technique for representing a set of product tags and for detecting tampering. When product tags are changed so that a device passes inspection, the changes can be detected by comparing the product credential reference ID generated using the modified tags and the original product credential reference ID associated with the product ID. The generation of a product credential reference ID can be achieved by many methods, one of which is a cryptographic hash function.

A cryptographic hash function is a procedure or algorithm that takes an arbitrary block of data and returns a fixed-size bit string, the hash value, such that an accidental or intentional change to the data will change the hash value. A cryptographic hash function ideally has four significant properties: it is easy to compute the hash value for a given input value, it is infeasible to generate an input value that has a given hash value, it is infeasible to modify an input value without changing the resulting hash value, and it is infeasible to find two input values with the same hash value.

In many embodiments of the invention, the product credential reference ID generation algorithm uses some or all of the product tags and optionally the product ID as inputs. The result is truncated to a prespecified length, which makes reading and recording by a human observer easier.

In several embodiments, the hash creation and truncation methods are updatable based on the product ID version. It is understood that a very small chance for collision in the credential reference ID exists; however, hash creation and truncation methods can be adapted to mitigate the problem. Although specific techniques are referenced above for generating credential reference IDs, any of a variety of processes appropriate to a specific application can be utilized in accordance with embodiments of the invention.

### Product Key

A product key is cryptographic data that can be utilized in the encryption and/or decryption of content and is associated with a product ID and/or product descriptor. In many embodiments, a product key is stored together with the product ID on a CE playback device. As will be discussed further below, the product key can be used in conjunction with one or more other encryption keys stored on the device to access encrypted data (e.g., other keys used to access content or the content itself).

### Storage of Product Identifier

In many embodiments of the invention, a product ID and associated data are stored on a playback device to enable the playback device to identify itself to a DRM system. A playback device, which stores a product ID, product credential reference ID, product tag data (the set of product tags), and product key in non-volatile memory, in accordance with an embodiment of the invention is shown in FIG. 3. The playback device 30 includes a processor 32, volatile memory 34, and non-volatile memory 36. In the illustrated embodiment, the non-volatile memory 36 includes a product ID 44, product tag data 46, a product credential reference ID 48, and a product key 50. As described above, in many embodiments, product ID 44 and product tag data 46 (e.g., constant tags and variable tags) form a product descriptor 52. As will be discussed below, the user ID, user key, and SSL certificate may be stored during a registration process, and the product ID, product credential reference ID, product tag data, and product key are typically loaded onto the device during manufacturing as part of the device's firmware.

Cryptographic data, which can be used to decrypt encrypted data or create secure connections to other systems, may also be stored in the non-volatile memory. In many embodiments, the cryptographic data includes (but is not limited to) a user ID 38 that is a unique identifier for a user account, a user key 40 used in decryption of content, and an SSL certificate 42 used in creating secure connections with other devices via Hypertext Transfer Protocol Secure (HTTPS) or a similar secure communication protocol. HTTPS is a combination of the Hypertext Transfer Protocol (HTTP) with Secure Sockets Layer/Transport Layer Security (SSL/TLS) protocol to provide encrypted communication and secure identification of a network device. In other embodiments, any of a variety of identifiers, keys, certificates and other types of information can be stored as cryptographic data on a playback device.

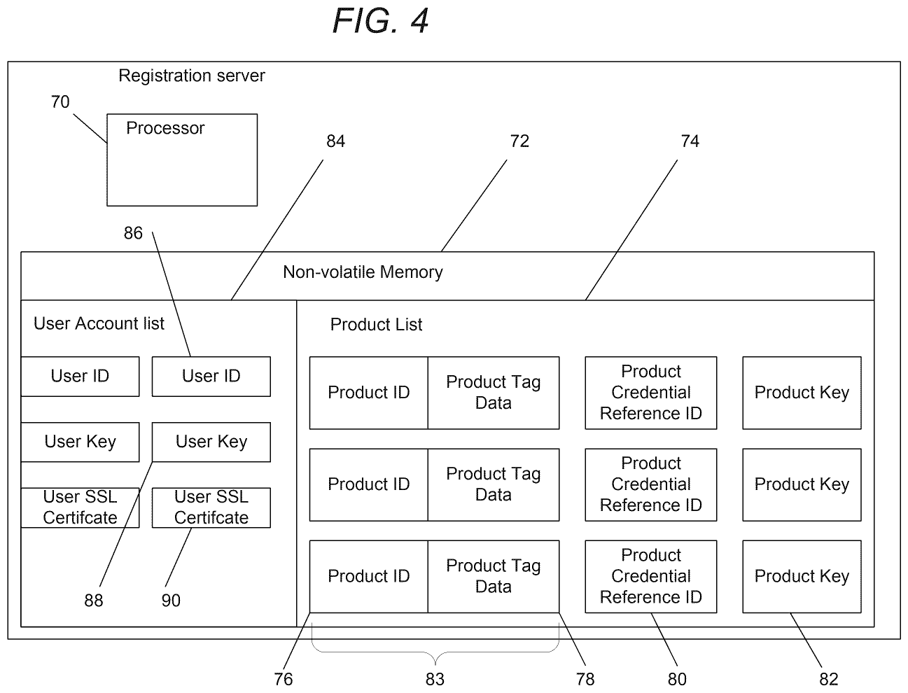

In several embodiments of the invention, product IDs and data associated with each ID are stored on a registration server. A registration server, which stores the product IDs, product credential reference IDs, sets of product tag data, and product keys in non-volatile memory, in accordance with an embodiment of the invention is shown in FIG. 4. The registration server includes a processor 70 and non-volatile memory 72. The non-volatile memory includes a product list 74, which includes at least one product ID 76, and its associated product tag data 78 (i.e., set of tags), product credential reference ID 80, and product key 82. In many embodiments, a product ID together with product tag data forms a product descriptor 83.

In some embodiments of the invention, the non-volatile memory also includes a user account list 84, which includes at least one user ID 86, and its associated user key 88 and a product SSL certificate 90. The data may also be stored in data structures other than lists, such as (but not limited to) databases. As can readily be appreciated, SSL certificates may be assigned uniquely to user accounts, to product classes, to device models, to individual devices or by numerous other classifications subject to the limitations and security policies of the DRM system.

### Issuing a Product Identifier in a Certification Process

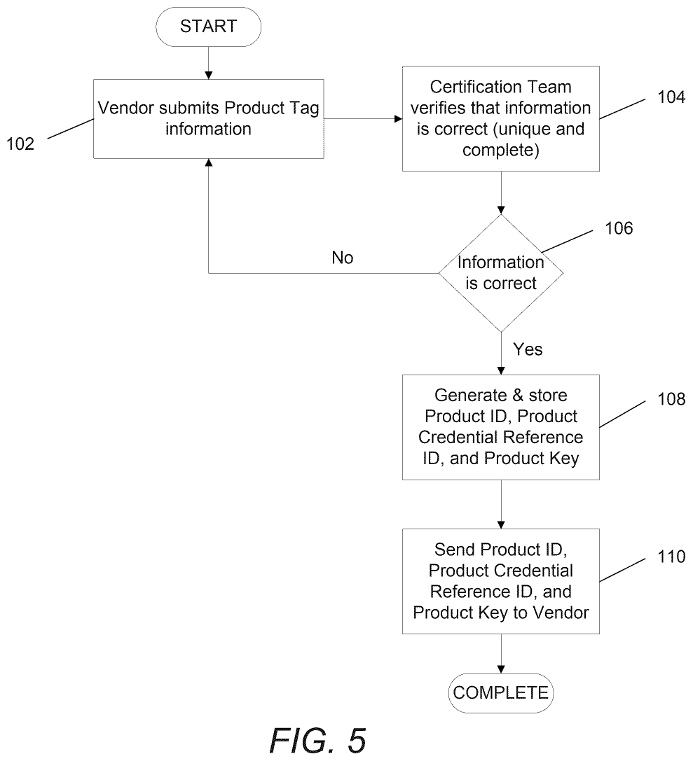

In many embodiments of the invention, a product ID is issued for a set of product tag data and the collection of product ID and the product tag data embedded in each device in the product line associated with that product tag data. A flow chart illustrating a process for issuing a product ID during a certification process, in accordance with an embodiment of the invention is shown in FIG. 5.

A vendor submits (102) product tag data to a certification team. The submission can be a paper form that is filled out with the relevant product tag data, an electronic form that transmits the information over a network, or other manual or automated process. The certification team verifies (104) that the information is correct—that it is unique (i.e., tags that should be unique to a product do not have the same values as tags in another product) and complete (i.e., tags are not missing). If the information is correct (106), the certification team generates (108) a product ID, product credential reference ID, and product key. The newly created product ID, product credential reference ID, and product key are associated with the product tag data and stored on a registration server. The product ID, product credential reference ID, product key, and the product ID version used to generate the product ID are sent (110) to the vendor to be stored on each device in the product line designated by the product ID. In many embodiments, a product descriptor is sent to the vendor that includes the product ID and product tag data.

In several embodiments of the invention, the DRM system owner packages into a dataload the encryption keys, algorithms, and/or other information and software instructions necessary for the device to communicate with DRM servers and receive content. The dataload is given to the manufacturer to be stored as firmware or as data in non-volatile memory on each device when it is manufactured. The product ID and associated data can be included in the dataload given to a manufacturer. The process described above with respect to FIG. 5, however, may be conducted differently in circumstances where a product ID is assigned to a class of devices (e.g. devices that utilize the same operating system) that include different hardware. In situations where a single product ID is assigned to a class of devices (e.g. mobile devices running a specific operating system), the tag values can be dynamically collected from the system and provided to the DRM system during the certification time using a specific certification application. Accordingly, any of a variety of processes for generating product identifying information and loading the information onto devices can be utilized in accordance with embodiments of the invention.

### Verifying the Product Identifier

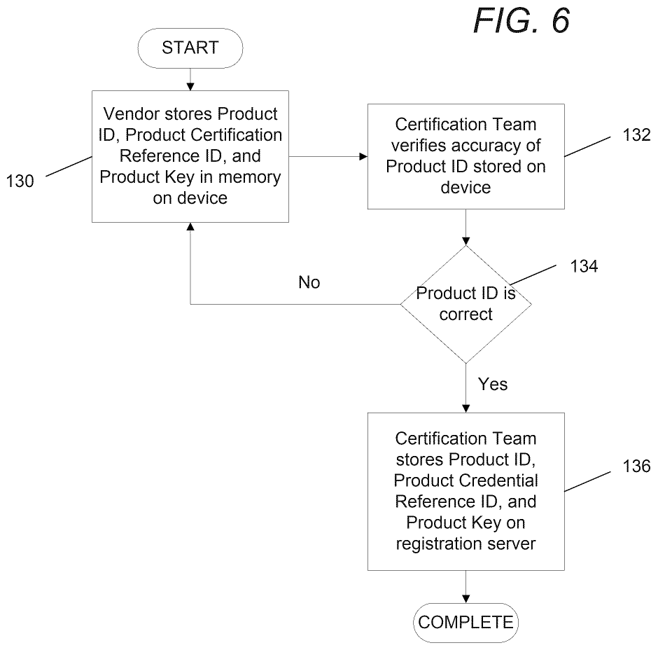

In many embodiments of the invention, certification of a product includes verifying that the product ID and associated tag data within the product descriptor are stored accurately on a device in the product line. A flow chart illustrating a process for verifying a product ID during a certification process, in accordance with an embodiment of the invention is shown in FIG. 6.

The vendor stores (130) a product ID, product certification reference ID, product tag data, and product key in memory on a device. In some embodiments of the invention, the product ID, product certification reference ID, product tag data, and product key can be contained within a dataload of information packaged to be loaded on the device during the manufacturing process as discussed above. In other embodiments, product tag data may be dynamically collected from a device using an application that reads and records tag values as described above, and the device may generate the product credential reference ID.

The certification team verifies (132) that the product ID and other information are stored accurately. A variety of methods can be utilized to complete the verification. An interface on the device may be configured such that the memory can be read directly. Firmware or software on the device may be programmed to respond to a device status call with the product ID, product credential reference identifier, and/or product tag data. Firmware or software on the device may also be programmed to show the information in human-readable format on a display integrated on the device or removably attached to the device. In several embodiments of the invention, the product credential reference identifier and at least one product tag are rendered viewable for certification purposes.

Verification may be facilitated by recalling and displaying the product ID and/or other information stored on the server for comparison with the corresponding information stored on the device. Another mechanism that can be utilized is to transfer the product ID and/or other information stored on the device to a terminal manually (e.g., by human interaction) or electronically (e.g., by a physical or wireless connection). The terminal electronically communicates the information to a registration server storing a copy of the information and the registration server responds with whether the information matches.

If the product ID and other information are correct (134), the certification team stores (136) the product ID, product credential reference ID, product tag data, and product key on the registration server. The information is associated as pertaining to one product line in the DRM system.

If the product ID and other information are not stored correctly, the certification team can investigate whether the product is participating in the DRM system without appropriate authorization. Although a specific process is illustrated in FIG. 6, any of a variety of processes for verifying the product ID and the product related credentials of a device can be utilized in accordance with embodiments of the invention.

### Using Product ID and Product Key in Registration and Authentication

In order to participate in a DRM system, a playback device typically connects to a registration server to register itself as an authorized device and connect to a content server each time a user wishes to stream or download content over a network. In several embodiments of the invention, a playback device sends its stored product ID, product credential reference ID, and/or product tag data to a server when registering with a registration server or connecting to a content server to play back streaming content. If the product ID is revoked or if product tag data does not match, the registration or connection attempt can be denied. Various embodiments of the invention utilize a product ID and associated information in authenticating a device to a server in a DRM system. In many embodiments, a product ID and product tag data are sent together as a product descriptor. In several embodiments of the invention, a device receives cryptographic data that it uses to decrypt content and the cryptographic data is encrypted with a product key. Systems and methods for implementing a product ID and product key in registration and authentication of a device are discussed below.

In many embodiments of the invention, registration of a product includes verifying that the product ID and associated data in the product descriptor are correct and that the product ID has not been revoked. A flow chart illustrating a registration process involving verification of a device's product ID, in accordance with an embodiment of the invention is shown in FIG. 7.

A device sends (170) its stored product ID and product ID version to a server. The server determines (172) if the product ID is in a revoked state. The server may maintain a list of revoked product IDs, may indicate revocation status in a database where the product ID is stored, or obtain revocation status of product IDs with any of a variety of other methods including (but not limited to) communicating with a remote system that maintains product ID revocation status. Revocation status may be determined based upon a product ID, any combination of one or more product tags, or any combination of product ID and product tags. Revocation can be checked by any process where a server receives a combination of product ID and product tags that determines revocation status, or information that can be used to look up the product ID and product tags. The server or the remote system can be configured to update the list or database using various manipulative functions including adding and removing product IDs. If the product ID is revoked, the device will not be permitted any protected functions (182) with the server, unless the product ID is restored (184). A protected function is any function that is restricted to devices that can be authenticated and can include (but are not limited to) registration of the device or issuance of content to the device.

If the product ID is not revoked, the server proceeds to authenticate (174) the session with the device. Authentication may entail the device using its SSL certificate to request a secure connection, although other methods may be used to ensure a secure connection (i.e., where the server and device have reliably identified the machine it is communicating with). For example, during initial registration of a device, the device may not have received an SSL certificate, so a trust relationship may be established by supplying user account details of the customer attempting to register the device.

A variety of protected functions can be allowed once the server has determined that the product ID has not been revoked. Functions may vary depending on the purpose for which the device is communicating to the server. In some embodiments of the invention, a device connects to a registration server for registration on the DRM system. Typically, such a transaction associates the device with a user account and the device receives (176) cryptographic data with which the device can decrypt content. The cryptographic data may include encryption keys associated with the user account such as user keys and other user account data associated with the user account such as (but not limited to) user IDs and product SSL certificates. The cryptographic data may further be encrypted with a product key that is associated with the product ID issued to the device and a device key that is associated with the class of device to which it belongs (e.g., DVD players, televisions).

In many embodiments of the invention, a device connects to a content server to request and receive digital content. The server encrypts (178) the content using cryptographic data that can include encryption keys associated with the user account such as user keys. The server sends the encrypted content to the device. The device may then store or immediately play back the received content, using its stored cryptographic data to access the content. In some embodiments of the invention, the device has user keys stored in memory that are encrypted with a product key and device key. The device key and the product key are used to decrypt (180) a user key and the user key is used to decrypt (181) the encrypted content. In other embodiments, any of a variety of combinations of keys and/or cryptographic data including a product key can be utilized to access encrypted content.

As discussed above, certain variable product tags, such as a Digital Secure Adaptive Streaming (DSAS) Software Version tag (PT10), can be used to indicate the version numbers for secure adaptive streaming software components implemented on the device. Platform components may include the playback software, operating system, and firmware. The collection of the Product ID and the product tags may indicate various device capabilities, such as the category of asset the device can play back. For example, categories of assets may be specified by quality, performance, or resource utilization characteristics that can include (but are not limited to) a bitrate, video resolution, file size, video format, or audio format. Some categories may be lower quality and/or less resource intensive than others. The playback software version or other version number may be associated with certain categories. Thus, a device may initially be manufactured with a software version that is capable of playing back certain categories of assets and later updated or upgraded to play back other categories of assets. A server may determine the playback capabilities based on a combination of the product ID, the constant, and the variable product descriptor tags. Alternatively, if no description for the capability using this combination is found, the server may match on the product ID and the constant product descriptor tag values. Again, if no description for the device capability using this combination is found, the server may perform a match only on the product ID field of the product descriptor and determine a gross set of capabilities that would be tied to the granularity of the products that the product ID is associated with. The identified capabilities can be used for a variety of purposes. In the context of an adaptive bitrate streaming system, the identified capabilities can be utilized to select streams appropriate to the specific device from a set of available streams for inclusion in a dynamically generated top level index file that is then provided to the playback device for use during adaptive bitrate streaming. In other applications, knowledge of device capabilities can be used in any of a variety of different ways appropriate to the specific application.

Although a specific process is illustrated in FIG. 7, any of a variety of processes can be utilized to verify the product ID of a device during registration and/or content distribution in accordance with embodiments of the invention. In several embodiments of the invention, a server can verify the product tag data stored on a device by comparing a generated product credential reference ID against a stored copy. A device sends its stored product tag data and product credential reference ID to the server. The server generates a product credential reference ID in accordance with the corresponding product ID version from the received product tag data. The server then compares the newly generated product credential reference ID with the product credential reference ID stored on the server for that set of product tag data and/or the product credential reference ID received from the device.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A method of delivering content to a playback device using a content server, the method comprising:
receiving a request for content from a playback device,
wherein the request comprises a product identifier associated with the playback device and data associated with a user account;
upon successful authentication of the data associated with the user account, transmitting a request to authenticate the playback device to a DRM server,
wherein the request to authenticate the playback device includes the product identifier and cryptographic information associated with the user account;
upon successful authentication of the playback device by the DRM server, encrypting cryptographic data associated with the requested content using a product key associated with the product identifier; and
transmitting the requested content and the cryptographic data associated with the requested content to the playback device,
wherein the cryptographic data associated with the requested content is decrypted using a product key stored on the playback device, and
wherein the content is decrypted using the decrypted cryptographic data associated with the requested content.

2. The method of claim 1, wherein the cryptographic data is associated with the user account.

3. The method of claim 1, wherein the product identifier identifies devices of at least one of a corresponding product model or a corresponding product line to the playback device.

4. The method of claim 1, wherein the product key associated with the product identifier is stored on the DRM server.

5. The method of claim 1, wherein the cryptographic data is further encrypted with a device key.

6. The method of claim 5, where in the device key is stored in a memory on the playback device.

7. The method of claim 1, further comprising playing back the decrypted content using the playback device.

8. The method of claim 1, wherein the product identifier is associated with one or more sets or product tag data, wherein a set of product tag data comprises product ID version, brand, ODM/manufacturer, device type, model number, base model number, silicon platform ID, certified playback profile, country, and digital secure adaptive streaming software version in the product tag data.

9. The method of claim 1, further comprising:
generating a product credential reference identifier from the product identifier,
wherein the product credential reference identifier is associated with cryptographic information;
sending a request for registration from the playback device to a registration server, where the request for registration includes the product credential reference identifier; and
receiving user account data from the registration server in response to the product credential reference identifier matching a copy of the product credential reference identifier on the registration server,
wherein the copy of the product credential reference identifier on the registration server also corresponds to the product identifier.

10. A system for delivering content to a playback device using a content server, the system comprising:
a playback device; and
a content server, wherein the content server is configured to:
receive a request for content from the playback device,
wherein the request comprises a product identifier associated with the playback device and data associated with a user account; and
upon successful authentication of the data associated with the user account, provide cryptographic information associated with the user account to the playback device;
a DRM server, wherein the DRM server is configured to:
receive a request to authenticate the playback device,
wherein the request includes cryptographic information associated with the user account and the product identifier;
upon successful authentication of the playback device by the DRM server, encrypt cryptographic data associated with the requested content using a product key associated with the product identifier; and
transmit the requested content and the cryptographic data associated with the requested content to the playback device,
wherein the cryptographic data associated with the requested content is decrypted using a product key stored on the playback device, and
wherein the content is decrypted using the decrypted cryptographic data associated with the requested content.

11. The system of claim 10, wherein the cryptographic data is associated with the user account.

12. The system of claim 10, wherein the product identifier identifies devices of at least one of a corresponding product model or a corresponding product line to the playback device.

13. The system of claim 10, wherein the product key associated with the product identifier is stored on the DRM server.

14. The system of claim 10, wherein the cryptographic data is further encrypted with a device key.

15. The system of claim 14, wherein the device key is stored in a memory on the playback device.

16. The system of claim 10, further comprising playing back the decrypted content using the playback device.

17. The system of claim 10, wherein the product identifier is associated with one or more sets or product tag data, wherein a set of product tag data comprises product ID version, brand, ODM/manufacturer, device type, model number, base model number, silicon platform ID, certified playback profile, country, and digital secure adaptive streaming software version in the product tag data.

18. The system of claim 10, wherein the playback device further generates a product credential reference identifier from the product identifier, wherein the product credential reference identifier is associated with cryptographic information.

19. The system of claim 18, further comprising:
a registration server configured to:
receive a request for registration from the playback device, where the request for registration includes the product credential reference identifier; and
transmit data associated with the user account in response to the product credential reference identifier matching a copy of the product credential reference identifier on the registration server,
wherein the copy of the product credential reference identifier on the registration server also corresponds to the product identifier.

20. A method of delivering content to a playback device using a content server, the method comprising:
generating, at a playback device a product credential reference identifier from the product identifier,
wherein the product credential reference identifier is associated with cryptographic information;
sending a request for registration from the playback device to a registration server, where the request for registration includes the product credential reference identifier;
receiving data associated with a user account from the registration server in response to the product credential reference identifier matching a copy of the product credential reference identifier on the registration server,
wherein the copy of the product credential reference identifier on the registration server also corresponds to the product identifier,
receiving a request for content from the playback device,
wherein the request comprises a product identifier associated with the playback device and data associated with the user account;
upon successful authentication of the data associated with the user account, transmitting a request to authenticate the playback device to a DRM server,
wherein the request to authenticate the playback device includes the product identifier;
upon successful authentication of the playback device by the DRM server, encrypting cryptographic data associated with the requested content using a product key associated with the product identifier; and
transmitting the requested content and the cryptographic data associated with the requested content to the playback device,
wherein the cryptographic data associated with the requested content is decrypted using a product key stored on the playback device, and
wherein the content is decrypted using the decrypted cryptographic data associated with the requested content.
